(19) United States
(12) Patent Application Publication
(10) Pub. No.: US 2014/0305948 A1
(43) Pub. Date: Oct. 16, 2014

(54) Culinary Article Comprising a Fluorocarbon-Resin Based Non-Stick Coating Having Improved Properties of Adhesion to the Support, and Method for the Production Thereof

(71) Applicants: Barbara Gantillon, Lechaux (FR); Jean-Luc Perillon, Saint Paul Trois Chateaux (FR); Marie-France Vallat, Wittenheim (FR); Vincent Roucoucles, Carspach (FR)

(72) Inventors: Barbara Gantillon, Lechaux (FR); Jean-Luc Perillon, Saint Paul Trois Chateaux (FR); Marie-France Vallat, Wittenheim (FR); Vincent Roucoucles, Carspach (FR)

(73) Assignees: SEB S.A., Ecully (FR); Universite de Haute Alsace, Mulhouse (FR); Centre National de la Recherche Scientifique-CNRS, Paris Cedex 16 (FR)

(21) Appl. No.: 14/240,957

(22) PCT Filed: Aug. 27, 2012
(86) PCT No.: PCT/FR2012/051939

§ 371 Date: Jun. 23, 2014

(30) Foreign Application Priority Data
Aug. 26, 2011 (FR) 1157580

(51) Int. Cl. A47J 36/02

(52) U.S. Cl. CPC A47J 36/025
USPC 220/573.2; 427/488

(57) ABSTRACT

The present invention relates to a cooking article a substrate having a contact surface at least partially made of metal and coated with a non-stick coating comprising at least one layer including at least one fluorocarbon resin alone or mixed with a thermostable coupling binder that is heat-resistant up to at least 200° C., the fluorocarbon resin and, if necessary, the thermostable coupling binder forming a sintered network. According to the invention, the contact surface comprises an interface layer consisting of a polymer layer formed by plasma polymerization from a precursor selected from among unsaturated carboxylic acids, the salts or esters thereof, saturated carboxylic acid vinyl esters, unsaturated dicarboxylic acids, the salts, esters, hemiesters or anhydride esters thereof, and unsaturated epoxides. The present invention also relates to a method for manufacturing such an article.

The present invention generally relates to culinary articles comprising a nonstick coating, and more particularly culinary articles comprising a fluorocarbon resin-based nonstick coating having improved properties of adhesion to the support. The present invention also relates to a method of producing such a culinary article.

Conventionally, it is used, by way of nonstick coating on the internal side of a culinary article, a sintered fluorocarbon resin-based coating (for example PTFE). Such coatings are known for both their nonstick properties and their resistance to chemical or thermal-type stresses.

However, such coatings have a limited adhesion on metallic supports, particularly aluminum, stainless steel or cast iron supports.

In order to overcome these problems, it is known by the skilled person to prepare the support surface by a deposit of a bonding primer comprising a coupling binder such as PAI or by chemical (for example of chemical etching type) or mechanical (for example brushing or sandblasting) surface treatments, or even a combination of these treatments.

However, a chemical surface treatment of etching type involves the use of polluting chemical baths and a mechanical surface treatment of brushing or sandblasting type (slightly) deforms the surface thus imposing an additional shaping operation. Likewise, the sandblasting medium or brushes must be regenerated or landfilled at the end of their useful life thus, generating pollution. In order to overcome these problems, the Applicant has developed a surface treatment by plasma process which allows the formation of an interface layer between the support and the nonstick coating, this interface layer improving the anchoring of the latter onto the support and thus allowing the coating to ensure a long term function without delamination risks.

More particularly, the present invention relates to an article comprising a support exhibiting a contact surface which is at least partially metallic which is covered by a nonstick coating comprising at least one fluorocarbon resin alone or in admixture with a coupling binder which is heat stable and resistant to a temperature of at least 200° C., the fluorocarbon resin and, if necessary, the heat stable coupling binder forming a sintered network,

characterized in that said contact surface comprises an interface layer consisting in a polymer layer formed by plasma polymerization from a precursor selected from among unsaturated carboxylic acids, the salts or esters thereof, saturated carboxylic acid vinyl esters, unsaturated dicarboxylic acids, the salts, esters, hemiesters, or anhydrides thereof and unsaturated epoxides.

either an entirely metallic support (in this case, the contact surface is entirely metallic), or a metallic support partially covered with a hard base (in this case, the contact surface is partially metallic, the complement being constituted by the hard base), the hard base being preferably made of enamel or ceramic.

The metallic portion of the support is advantageously in aluminum or aluminum alloy, in cast aluminum (or cast aluminum alloy), or in stainless steel.

By way of non limiting examples of culinary articles in compliance with the present invention, it will be particularly cited culinary articles such as saucepans and frying pans, woks and high-sided pans, stew pans and cooking pots, crepe makers, grills, pastry molds and plates, barbecue plates and grills, preparation bowls.

By way of example of unsaturated carboxylic acid, it may be cited methacrylic acid.

By way of example of unsaturated dicarboxylic acid, it may be cited maleic anhydride.

By way of examples of vinyl or allylic esters of saturated carboxylic acids it may be cited vinyl acetate.

By way of example of unsaturated epoxides, it may be cited glycidil methacrylate.

The interface layer formed by plasma polymerization may thus advantageously be a polymeric layer substantially constituted of glycidil polymethacrylate or poly(maleic anhydride).

In order to promote the adhesion of the nonstick coating onto the contact surface of the support, it may be advantageous that the nonstick coating comprises a bonding primer layer and at least one top coat, said primer layer comprising, apart from the fluorocarbon resin sintered network, at least one coupling binder.

It may also be advantageous that the contact surface be a surface chemically or mechanically treated beforehand. Such a treatment also makes it possible to modify the surface conditions and reach, in particular, surface tensions in the magnitude of 72 mN/m on aluminum supports, thus improving the substrate wettability. In the specific case of aluminum alloys, this treatment creates a nanometric oxidation layer which is favorable to the adhesion if only the coating is applied rapidly after the plasma treatment (in the magnitude of 60 seconds at the most to apply the nonstick coating on the support thus treated by plasma process).

For this alternative embodiment consisting in treating prior to the formation of the fluorocarbon resin-based nonstick coating, it is possible to use a nonstick coating substantially free from coupling binder.

The fluorocarbon resin used in the nonstick coating of the article according to the invention may advantageously be selected from among polytetrafluoroethylene (PTFE), tetrafluoroethylene and perfluoro propyl vinyl ether copolymer (PFA), tetrafluoroethylene and hexafluoropropylene (FEP) copolymer, and mixtures thereof (particularly a PTFE and PFA mixture).

The coupling binder used in the nonstick coating of the article according to the invention may be advantageously selected from among polyamides-imides (PAI), polyether-imides (PEI), polyamides (PI), polyetherketones (PEK), polyether ether ketones (PEEK), polythersulfones (PES) and polyphenylene sulfides (PPS).

The present invention further relates to a method of producing an article according to the invention, comprising the following steps of:
providing a support at least partially metallic and exhibiting two opposite sides;
forming a nonstick coating on one of the sides of said support comprising
preparing at least one composition based on at least one fluorocarbon resin in particulate form, said fluorocarbon resin being alone or in admixture with a coupling binder which is heat stable and resistant to a temperature of at least 200° C.;
applying said composition on one of the sides (21) of said support to form a fluorocarbon resin layer;
curing said article thus coated with said fluorocarbon resin layer at a temperature ranging between 350° C. and 450° C. for sintering said layer, such as to obtain a nonstick fluorocarbon resin-based coating (3) forming a continuous network;

said method being characterized in that it further comprises, before applying the fluorocarbon resin-based composition on the side of the support (contact surface), a plasma polymerization step to form, on said contact surface, a polymer layer from a precursor selected from among unsaturated carboxylic acids, the salts or esters thereof, saturated carboxylic acid vinyl esters, unsaturated dicarboxylic acids, the salts, esters, hemiesters, or anhydrides thereof and unsaturated epoxides.

The fluorocarbon resin and the heat stable coupling binder are such as defined previously.

By way of example of unsaturated carboxylic acid, it may be cited methacrylic acid.

By way of example of unsaturated dicarboxylic acid, it may be cited maleic anhydride.

By way of examples of saturated carboxylic acid vinyl or allylic esters it may be cited vinyl acetate.

In the method according to the invention, are preferably used as precursors, maleic anhydride or glycidil methacrylate.

Advantageously, the formation of the nonstick coating may comprise:
applying a composition of bonding primer on the contact surface to form a bonding primer layer, the primer composition comprising at least one fluorocarbon resin in particulate form and at least one coupling binder which is heat stable and resistant to a temperature of at least 200° C.; and
applying at least one finishing composition on the primer layer to form a top coat, the finishing composition comprising at least one fluorocarbon resin in particulate form.

It may also be advantageous that the contact surface be treated chemically (for example degreased or satin-finished) or mechanically (particularly brushed). In this case, it is possible to form a nonstick coating by applying, directly onto the previously treated contact surface, at least one finishing composition substantially free from coupling binder, to form at least one top coat.

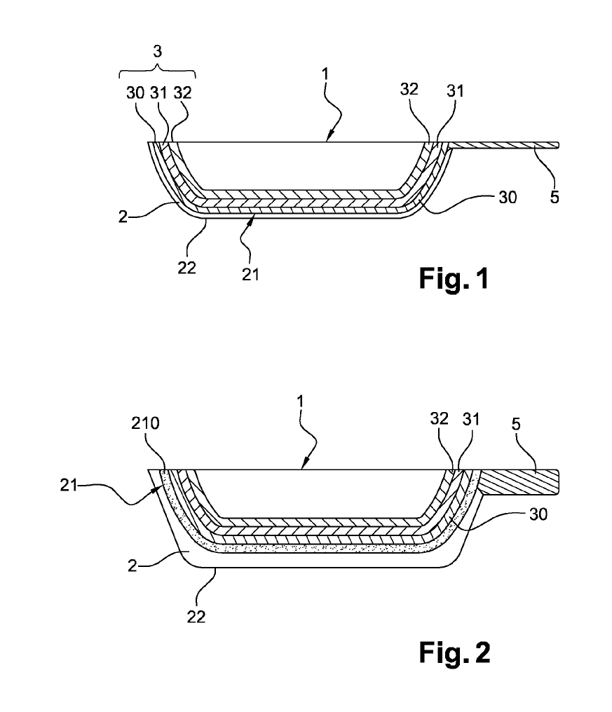

Other advantages and features of the present invention will become apparent from the following description, given by way of non limiting example and made with reference to the accompanying drawings:
FIG. 1 represents a schematic cross-sectional view of an example of culinary article in accordance with the invention according to the prior art (support untreated by plasma and bonding primer),
FIG. 2 represents a schematic cross-sectional view of a culinary article in accordance with the invention (support treated by plasma polymerization with bonding primer),

The identical elements represented on FIGS. 1 and 2 are identified by identical numerical references.

On FIGS. 1 and 2, it has been represented by way of example of article according to the invention, a frying pan 1 comprising a metallic support 2 in the form of a hollow bowl and a gripping handle 5. The support 2 comprises an internal side 21 (contact surface) which is the face oriented on the side wherein the food is to be deposited in the frying pan 1, and an external side 22 which is intended to be arranged towards an external heat source. The internal side 21 is coated by a nonstick coating 3, which comprises successively from the support 2 a bonding primer layer 30 and two top coats 31, 32. The primer 30, finishing 31 and decoration 32 layers are PTFE-based.

The support 2 of the frying pan represented on FIG. 1 has not been treated by plasma process in accordance with the present invention, whereas that of the frying pan represented on FIG. 2 has been treated by plasma polymerization, leading to the formation of a polymer layer 210 on the support contact surface 21.

The invention is illustrated in further detail in the following examples.

In these examples, unless otherwise specified, all percentages and parts are expressed by weight.

### EXAMPLES

### Products

Supports
smooth aluminum plates (shade 4917) 10 cm long and 5 cm wide,
brushed aluminum plates (shade 4917) 10 cm long and 5 cm wide,
aluminum plates (shade 4917) 10 cm long and 5 cm wide, satin-finished (treated by immersion in a soda bath then neutralized with acid and finally rinsed).
smooth stainless steel plates, 10 cm long and 5 cm wide,

Precursors
maleic anhydride
glycidil methacrylate,

Primer Composition 1 CP1 (without PAI)

| | |
|---|---|
| PES resin (micronized powder): | 0.5 g |
| LUDOX AM30 (colloidal silica | 21.5 g |
| in water at 30%): | |
| PTFE (PTFE dispersion at 60%) | 78 g |
| Total: | 100 g |

Primer Composition 1 CP2 (with PAI)

| | |
|---|---|
| PAI resin (29% dry in NEP): | 58.9 g |
| LUDOX AM30 (colloidal silica | 19.3 g |
| in water at 30%): | |
| Carbon black (25% in water) | 5.6 g |
| PTFE (PTFE dispersion at 60%) | 16.2 g |
| Total: | 100 g |

Finishing Composition

| | |
|---|---|
| PTFE dispersion (60% dry) | 80.6 g |
| PFA dispersion (50% dry) | 0.5 g |
| Carbon black (25% dry) | 0.02 g |
| Spreading agents (surfactants) | 2.23 g |
| Water: | 8.02 g |
| Xylene: | 6.50 g |
| Acrylic copolymer >95%: | 0.6 g |
| Triethanolamine: | 0.22 g |
| Iriodin 153: | 0.2 g |
| Propylene glycol: | 1.11 g |
| Total | 100 g |

Plasma Treatment Device and Corresponding Trial Protocol
device used in the framework of a vacuum plasma:
   deposition reactor composed of a cylindrical stainless steel enclosure provided materials and precursors, as well as vacuum generating devices (10⁻³ mmHg)
method comprising:
   plasma treatment by polymerization of one at least of the precursors.
   coating of the primer composition CP1, then the finishing composition,
   IR oven at 100° C.
   sintering in a standard oven at 430° C. during approximately 11 minutes.

Test

Evaluation of the Adhesion of a Nonstick Coating on a Metallic Substrate

A cross cut test is performed according to standard ISO 2409, followed by immersing the article for 9 hours (per 3 cycles of three hours in boiling water). Then, the nonstick coating is checked to see if there is detachment or not. The notation is as follows:
no square must be detached in order to obtain a notation of 100 (excellent adhesion);
In the event of detachment, the measured value is equal to 100 minus the number of detached squares.
The notation is as follows:
   The adhesion of the nonstick coating on the support is judged to be industrially acceptable if the value is equal to or higher than 95, this adhesion level is thus, suitable for any type of culinary article whatever its mechanical stress level.
   The adhesion of the nonstick coating on the support is still judged to be industrially acceptable if its value ranges between 90 and 95. However, its application should be limited to articles with hardly any mechanical stress such as for example articles for baking or oven dishes.

The set of plates has been coated with a nonstick coating 3, comprising or not a primer composition (CP1 or CP2) and a finishing composition, after having already been subjected or not to a plasma process treatment in accordance with the method according to the invention.

The adhesion of the nonstick coating on the metallic substrate was then evaluated for the set of thus, coated plates and the results obtained from this test are gathered in table 1.

These results show that in all cases a plasma treatment improves the adhesion of a fluorocarbon resin based nonstick coating (particularly PTFE based) on all types of supports.

More particularly, on a brushed or satin-finished aluminum support, the plasma treatment according to the method of the invention allows to avoid a primer layer.

For a smooth support, in aluminum or stainless steel, the plasma treatment allows to avoid the presence of a coupling binder of PAT type in the primer layer (for any type of precursor), and even a primer layer (particularly with a precursor such as glycidil methacrylate).

TABLE 1
adhesion test results

| | | Control tests | Plasma polymerization | Plasma polymerization |
|---|---|---|---|---|
| | | no plasma process | (maleic anhydride) | (glycidil methacrylate) |
| Type of support 2 | Non-stick coating | treatment | (10⁻³ mmHg) | (10⁻³ mmHg) |
| smooth aluminum | Without primer | 0% | 20% | 99% |
| plates | | | | |
| smooth aluminum | With primer CP1 | 80% | 95% | 100% |
| plates | | | | |
| smooth aluminum | with primer CP2 | 98% | 100% | 100% |
| plates | | | | |
| brushed aluminum | Without primer | 0% | 100% | 100% |
| plates | | | | |
| brushed aluminum | With primer CP1 | 95% | 100% | 100% |
| plates | | | | |
| brushed aluminum | with primer CP2 | 98% | 100% | 100% |
| plates | | | | |
| satin-finished | Without primer | 80% | 100% | 100% |
| aluminum plates | | | | |
| satin-finished | With primer CP1 | 98% | 100% | 100% |
| aluminum plates | | | | |
| satin-finished | With primer CP2 | 100% | 100% | 100% |
| aluminum plates | | | | |
| smooth stainless | Without primer | 0% | 40% | 99% |
| steel plates | | | | |
| smooth stainless | With primer CP1 | 95% | 100% | 100% |
| steel plates | | | | |

1. A culinary article comprising a support exhibiting a contact surface at least partially metallic and which is covered by a nonstick coating comprising at least one layer comprising at least one fluorocarbon resin alone or in admixture with a coupling binder which is heat stable and resistant to a temperature of at least 200° C., the fluorocarbon resin and, if necessary, the heat stable coupling binder forming a sintered network,
wherein said contact surface comprises an interface layer consisting in a polymer layer formed by plasma polymerization from a precursor selected from among unsaturated carboxylic acids, the salts or esters thereof, saturated carboxylic acid vinyl esters, unsaturated dicarboxylic acids, the salts, esters, hemiesters, or anhydrides thereof and unsaturated epoxides.

2. The culinary article according to claim 1, wherein the support is either an entirely metallic support, or a metallic support partially covered with a hard base.

3. The culinary article according to claim 1, wherein the interface layer is a glycidil polymethacrylate or a poly(maleic anhydride) layer formed by plasma polymerization.

4. The culinary article according to claim 1, wherein the nonstick coating comprises a bonding primer layer and at least one top coat, said primer layer comprising, apart from the fluorocarbon resin sintered network, at least one coupling binder.

5. The culinary article according to claim 1, wherein said contact surface is a chemically or mechanically treated surface.

6. The article according to claim 5, wherein the nonstick coating is substantially free from coupling binder.

7. The culinary article according to claim 1, wherein the fluorocarbon resin is selected from among polytetrafluoroethylene (PTFE), tetrafluoroethylene and perfluoro propyl vinyl ether copolymer (PFA), tetrafluoroethylene and hexafluoropropylene (FEP) copolymer, and mixtures thereof.

8. The culinary article according to claim 1, wherein the coupling binder is selected from among polyamides-imides (PAI), polyether-imides (PEI), polyamides (PI), polyetherketones (PEK), polyether ether ketones (PEEK), polythersulfones (PES) and polyphenylene sulfides (PPS).

9. The culinary article according to claim 1, wherein the support of which exhibits an internal concave side intended to be in contact with the food liable to be introduced into said article, and an external convex side intended to be disposed towards a heat source.

10. A method of producing a culinary article, comprising the following steps of:
providing a support at least partially metallic, exhibiting two opposite sides;
forming a nonstick coating on one of the sides of said support comprising:
preparing at least one composition based on at least one fluorocarbon resin in particulate form, said fluorocarbon resin being alone or in admixture with a coupling binder which is heat stable and resistant to a temperature of at least 200° C.;
applying said composition on one of the sides of said support to form a fluorocarbon resin layer;
curing said article thus coated by said fluorocarbon resin layer at a temperature ranging between 350° C. and 450° C. to sinter said layer, so as to obtain a nonstick fluorocarbon resin-based coating forming a continuous network;
said method further comprising, before applying the fluorocarbon resin based composition on the side of the support, a plasma polymerization step to form, on said contact surface, a polymer layer from a precursor selected from among unsaturated carboxylic acids, the salts or esters thereof, saturated carboxylic acid vinyl esters, unsaturated dicarboxylic acids, the salts, esters, hemiesters, or anhydrides thereof and unsaturated epoxides.

11. The method according to claim 10, wherein the precursor is glycidil methacrylate or maleic anhydride.

12. The method according to claim 10, wherein the formation of the nonstick coating comprises:
applying a composition of bonding primer on the contact surface to form a bonding primer layer, said primer composition comprising at least one fluorocarbon resin in particulate form and at least one coupling binder which is heat stable and resistant to a temperature of at least 200° C.; and
applying at least one finishing composition on the primer layer to form a top coat, said finishing composition comprising at least one fluorocarbon resin in particulate form.

13. The method according to claim 10, wherein said contact surface is a chemically or mechanically treated surface.

14. The method according to claim 13, wherein the contact surface is brushed, degreased or satin-finished.

15. The method according to claim 13, wherein the formation of the nonstick coating includes applying at least one finishing composition substantially free from coupling binder on the contact surface, to form a top coat, said finishing composition comprising at least one fluorocarbon resin in particulate form.
